(19) United States
(12) Patent Application Publication
(10) Pub. No.: US 2015/0062954 A1
(43) Pub. Date: Mar. 5, 2015

(54) PHOSPHOR PRINTING ON LIGHT DIFFUSING FIBER BASED TEXTILE

(71) Applicant: CORNING INCORPORATED, Corning, NY (US)

(72) Inventors: Carl Edgar Crossland, Horsehead, NY (US); Vineet Tyagi, Painted Post, NY (US)

(73) Assignee: CORNING INCORPORATED, Corning, NY (US)

(21) Appl. No.: 14/010,895

(22) Filed: Aug. 27, 2013

(51) Int. Cl. F21V 8/00; F21K 99/00

(52) U.S. Cl. CPC G02B 6/0008; F21K 9/52
USPC 362/552; 362/558; 362/553; 362/555

(57) ABSTRACT

A luminary fabric, useful for a variety of applications including signage, has at least one light-diffusing optical fiber woven, knitted, crocheted or otherwise integrated into the fabric. The light-diffusing optical fiber is coupled to at least one light source such as a laser or a light emitting diode. At least one coating is applied over at least a section of the outer surface of the optical fiber along its length. The coating contains at least one luminophore that absorbs energy from the light source and luminesces at a different higher wavelength. Multiple coatings containing one or more luminophores, one or more pigments, and/or one or more dyes may be employed to provide a variety of interesting visual effects.

### CROSS-REFERENCE TO RELATED APPLICATIONS

Not Applicable.

### FIELD OF THE DISCLOSURE

This disclosure pertains to illuminated structures and more particularly to illuminated structures comprised of light diffusing fibers.

### BACKGROUND OF THE DISCLOSURE

Light diffusing optical fibers are optical fibers that emit light from surfaces along the length of the fiber, rather than only propagating light along the axis of the fiber. As with optical fibers commonly used in optical telecommunications, light diffusing optical fibers can include a core region and a cladding region made of a material having a lower index of refraction than the material of the core region. Additionally, light diffusing optical fibers are configured to scatter guided light away from the core and through an outer surface of the cladding region. Scattering of light away from the core and through an outer surface of the cladding region can be achieved by situating nano-sized (e.g., 10 nm to 1000 nm) structures within the glass core or at a core-cladding boundary. The nano-sized structures can be voids. Properties and characteristics of light-diffusing optical fibers, and processes for making the same are described in U.S. Patent Application Publication No. 2013/0090402 A1, the entire content of which is incorporated by reference.

It is disclosed in the patent literature pertaining to light-diffusing optical fibers that applications for such fibers include bioreactors, signage, special lighting (e.g., to provide decorative accents), sensor and measurement applications, automotive applications and consumer electronics.

### SUMMARY OF THE DISCLOSURE

This disclosure pertains to luminary fabrics that include at least one fiber that is a light-diffusing optical fiber, at least one light source coupled to the light diffusing fiber, and at least one luminophore coating applied over at least a section of the light diffusing fiber.

The luminary fabric can be a textile material comprising interlacing fibers; woven, knitted, or crocheted fabrics; and non-woven fabrics, in which at least one fiber is a light-diffusing optical fiber coupled to at least one light source, and in which a luminophore coating is present on at least a section of an outer surface of the light-diffusing optical fiber.

The light source coupled to the light-diffusing optical fiber can be either a laser or light emitting diode.

The luminophore coating may contain at least one phosphor compound, at least one fluorophore compound, or combination of at least one phosphor and at least one chromophore.

### BRIEF DESCRIPTION OF THE DRAWINGS

FIG. 1 is a schematic side view of a section of an example embodiment of light-diffusing optical fiber.

FIG. 2 is a schematic cross-section of the optical fiber of FIG. 1 as viewed along the direction 2-2.

FIG. 3A is a schematic illustration of relative refractive index plot versus fiber radius for an exemplary embodiment of light diffusing fiber.

FIG. 3B is a schematic illustration of relative refractive index plot versus fiber radius for another exemplary embodiment of light diffusing fiber.

FIG. 3C illustrates another exemplary embodiment of a light diffusing fiber.

FIGS. 4A and 4B depict fiber attenuation (loss) in dB/m versus wavelength (nm).

FIG. 5 illustrates a fiber deployment that utilizes two light passes within a single fiber.

FIG. 6A illustrates the intensity distribution along the fiber when the fiber made with uniform tension (example A) and variable tension (example B).

FIG. 6B illustrates the scattering distribution function with white ink and without ink.

FIG. 7 illustrates scattering for fiber shown in FIG. 5 (with reflective mirror at coupled to the rear end of the fiber), and also for a fiber utilizing white ink in its coating.

FIG. 8 illustrates a screen-printed fabric display or sign incorporating light-diffusing optical fibers.

FIG. 9 illustrates a laminated or layered sign or display comprising a screen-printed fabric incorporating light-diffusing optical fibers that is disposed between two outer layers that can protect and support the fabric, at least one of the outer layers being transparent to allow light emitted from the fabric to be displayed.

FIG. 10 illustrates a laminated or layered sign or display comprising a screen-printed fabric incorporating light-diffusing optical fibers that is supported on another layer of material, which may or may not be transparent.

FIG. 11 illustrates a screen-printed fabric display employing two different illuminophores and two different light source, each of which excites only one of the two illuminophores to induce luminescence.

### DETAILED DESCRIPTION OF THE DISCLOSED EMBODIMENTS

Reference will now be made in detail to the present preferred embodiments, examples of which are illustrated in the accompanying drawings. Whenever possible, the same reference numerals will be used throughout the drawings to refer to the same or like parts.

Various modifications and alterations may be made in the following examples within the scope of the claims, and aspects of the different examples may be combined in different ways to achieve yet further examples. Accordingly, the true scope of the claims is to be understood from the entirety of the present disclosure, in view of, but not limited to, the embodiments described herein.

The term “flexible light diffusing waveguide” refers to a flexible optical waveguide or (e.g., an optical fiber) employing nano-sized structures that are utilized to scatter or diffuse light out of the sides of the fiber, such that light is guided away from the core of the waveguide and through the outer surfaces of the waveguide to provide illumination. Concepts relevant to the underlying principles of the claimed subject matter are disclosed in U.S. patent application Ser. No. 12/950,045 (U.S. Patent Application Publication No. US 2011/0122646 A1), which is incorporated in its entirety herein by reference.

The term “light source” refers to a laser, light emitting diode or other component capable of emitting electromagnetic radiation that is either in the visible light range of wavelengths or is of a wavelength that can interact with a luminophore to emit light in the visible wavelength range.

The term “luminophore” refers to an atom or chemical compound that manifests luminescence, and includes a variety of fluorophores and phosphors.

The following terms and phrases are used in connection to light diffusing fibers having nano-sized structures.

The “refractive index profile” is the relationship between the refractive index or the relative refractive index and the waveguide (fiber) radius.

The “relative refractive index percent” is defined as

Δ(r)%=100×[n(r)²−n_{REF}²)]/2n(r)²,

where n(r) is the refractive index at radius r, unless otherwise specified. The relative refractive index percent is defined at 850 nm unless otherwise specified. In one aspect, the reference index n_{REF} is silica glass with a refractive index of 1.452498 at 850 nm, in another aspect it is the maximum refractive index of the cladding glass at 850 nm. As used herein, the relative refractive index is represented by Δ and its values are given in units of “%”, unless otherwise specified. In cases where the refractive index of a region is less than the reference index n_{REF}, the relative index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive and the region can be said to be raised or to have a positive index.

An “updopant” is herein considered to be a dopant which has a propensity to raise the refractive index relative to pure undoped SiO₂. A “downdopant” is herein considered to be a dopant which has a propensity to lower the refractive index relative to pure undoped SiO₂. An updopant may be present in a region of an optical fiber having a negative relative refractive index when accompanied by one or more other dopants which are not updopants. Likewise, one or more other dopants which are not updopants may be present in a region of an optical fiber having a positive relative refractive index. A downdopant may be present in a region of an optical fiber having a positive relative refractive index when accompanied by one or more other dopants which are not downdopants.

Likewise, one or more other dopants which are not downdopants may be present in a region of an optical fiber having a negative relative refractive index.

The term “a-profile” or “alpha profile” refers to a relative refractive index profile, expressed in terms of Δ(r) which is in units of “%”, where r is radius, which follows the equation,

Δ(r)=Δ(rₒ)(1−[|r−rₒ|/(r₁−rₒ)]^{α}),

where rₒ is the point at which Δ(r) is maximum, r₁ is the point at which Δ(r)% is zero, and r is in the range r₁≦r≦r_{f}, where Δ is defined above, r₁ is the initial point of the a-profile, r_{f} is the is final point of the a-profile, and α is an exponent which is a real number.

As used herein, the term “parabolic” therefore includes substantially parabolically shaped refractive index profiles which may vary slightly from an a value of 2.0 at one or more points in the core, as well as profiles with minor variations and/or a centerline dip. In some exemplary embodiments, a is greater than 1.5 and less than 2.5, more preferably greater than 1.7 and 2.3 and even more preferably between 1.8 and 2.3 as measured at 850 nm. In other embodiments, one or more segments of the refractive index profile have a substantially step index shape with an a value greater than 8, more preferably greater than 10 even more preferably greater than 20 as measured at 850 nm.

The term “nano-structured fiber region” describes the fiber having a region or area with a large number (greater than 50) of gas filled voids, or other nano-sized structures, e.g., more than 50, more than 100, or more than 200 voids in the cross-section of the fiber. The gas filled voids may contain, for example, SO₂, Kr, Ar, CO₂, N₂, O₂, or mixture thereof. The cross-sectional size (e.g., diameter) of nano-sized structures (e.g., voids) as described herein may vary from 10 nm to 1 μm (for example, 50 nm-500 nm), and the length may vary from 1 millimeter 50 meters (e.g., 2 mm to 5 meters, or 5 mm to 1 m range).

In standard single mode or multimode optical fibers, the losses at wavelengths less than 1300 nm are dominated by Rayleigh scattering. These Rayleigh scattering losses Lₛ are determined by the properties of the material and are typically about 20 dB/km for visible wavelengths (400-700 nm). Rayleigh scattering losses also have a strong wavelength dependence (i.e., L_{S} oc 1/λ⁴, see FIG. 4B, comparative fiber A), which means that at least about 1 km to 2 km of the fiber is needed to dissipate more than 95% of the input light. Shorter lengths of such fiber would result in lower illumination efficiency, while using long lengths (1 km to 2 km, or more) can be more costly and can be difficult to manage. The long lengths of fiber, when used in a bioreactor or other illumination system may be cumbersome to install.

In certain configurations of lighting applications it is desirable to use shorter lengths of fiber, for example, 1-100 meters. This requires an increase of scattering loss from the fiber, while being able to maintain good angular scattering properties (uniform dissipation of light away from the axis of the fiber) and good bending performance to avoid bright spots at fiber bends. A desirable attribute of at least some of the embodiments described herein is uniform and high illumination along the length of the fiber illuminator. Because the optical fiber is flexible, it allows a wide variety of the illumination shapes to be deployed. It is preferable to have no bright spots (due to elevated bend losses) at the bending points of the fiber, such that the illumination provided by the fiber does not vary by more than 30%, preferably less than 20% and more preferably less than 10%. For example, in at least some embodiments, the average scattering loss of the fiber is greater than 50 dB/km, and the scattering loss does not vary more than 30% (i.e., the scattering loss is within ±30% of the average scattering loss) over any given fiber segment of 0.2 m length. According to at least some embodiments, the average scattering loss of the fiber is greater than 50 dB/km, and the scattering loss does not vary more than 30% over the fiber segments of less than 0.05 m length. According to at least some embodiments, the average scattering loss of the fiber is greater than 50 dB/km, and the scattering loss does not vary more than 30% (i.e., ±30%) over the fiber segments 0.01 m length. According to at least some embodiments, the average scattering loss of the fiber is greater than 50 dB/km, and the scattering loss does not vary more than 20%(i.e., ±20%) and preferably by not more than 10% (i.e., ±10%) over the fiber segments 0.01 m length.

In at least some embodiments, the intensity variation of the integrated (diffused) light intensity coming through sides of the fiber at the illumination wavelength is less than 30% for the target length of the fiber, which can be, for example, 0.02-100 m length. It is noted that the intensity of integrated light intensity through sides of the fiber at a specified illumination wavelength can be varied by incorporating fluorescent material in the cladding or coating. The wavelength of the light scattering by the fluorescent material is different from the wavelength of the light propagating in the fiber.

In some of the following exemplary embodiments we describe fiber designs with a nano-structured fiber region (region with nano-sized structures) placed in the core area of the fiber, or very close to the core. Some of the fiber embodiments have scattering losses in excess of 50 dB/km (for example, greater than 100 dB/km, greater than 200 dB/km, greater than 500 dB/km, greater than 1000 dB/km, greater than 3000 dB/km, greater than 5000 dB/km), the scattering loss (and thus illumination, or light radiated by these fibers) is uniform in angular space.

In order to reduce or to eliminate bright spots as bends in the fiber, it is desirable that the increase in attenuation at a 90° bend in the fiber is less than 5 dB/turn (for example, less than 3 dB/turn, less than 2 dB/turn, less than 1 dB/turn) when the bend diameter is less than 50 mm. In exemplary embodiments, these low bend losses are achieved at even smaller bend diameters, for example, less than 20 mm, less than 10 mm, and even less than 5 mm. Preferably, the total increase in attenuation is less than 1 dB per 90 degree turn at a bend radius of 5 mm.

Preferably, according to some embodiments, the bending loss is equal to or is lower than the intrinsic scattering loss from the core of the straight fiber. The intrinsic scattering is predominantly due to scattering from the nano-sized structures. Thus, according to at least the bend insensitive embodiments of optical fiber, the bend loss does not exceed the intrinsic scattering for the fiber. However, because the scattering level is a function of bending diameter, the bending deployment of the fiber depends on its scattering level. For example, in some of the embodiments, the fiber has a bend loss less than 3 dB/turn, preferably less than 2 dB/turn, and the fiber can be bent in an arc with a radius as small as 5 mm radius without forming bright spots.

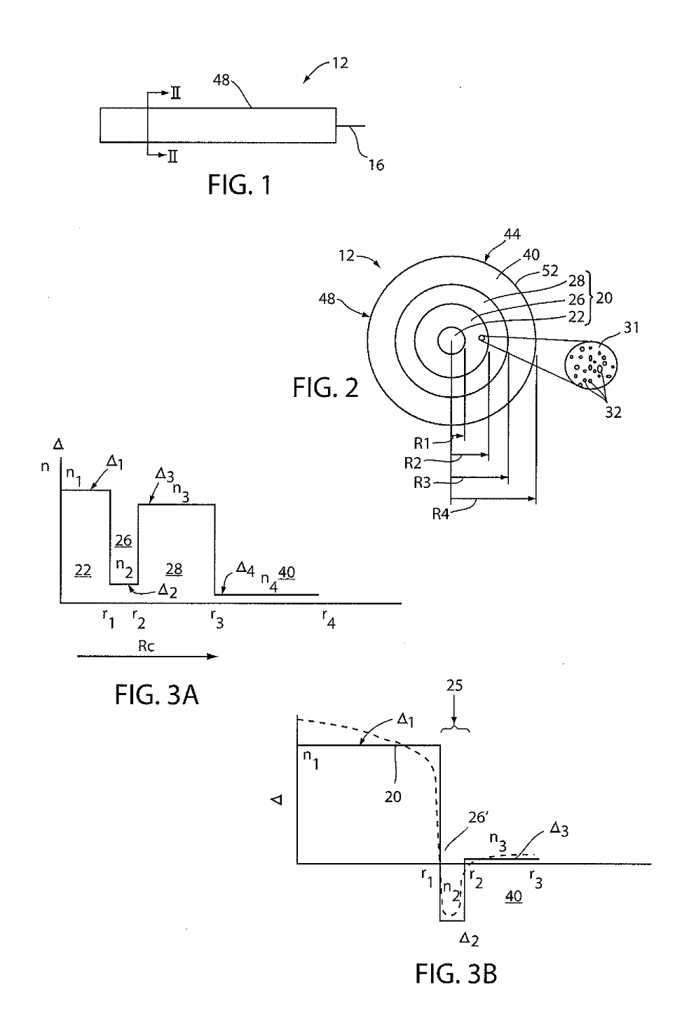

FIG. 1 is a schematic side view of a section of an example embodiment of a light diffusing fiber with a plurality of voids in the core of the light diffusing optical fiber (hereinafter “fiber”) 12 having a central axis (“centerline”) 16. FIG. 2 is a schematic cross-section of light diffusing optical fiber 12 as viewed along the direction 2-2 in FIG. 1. Light diffusing fiber 12 can be, for example, any one of the various types of optical fiber with a nano-structured fiber region having periodic or non-periodic nano-sized structures 32 (for example voids). In an example embodiment, fiber 12 includes a core 20 divided into three sections or regions. These core regions are: a solid central portion 22, a nano-structured ring portion (inner annular core region) 26, and outer, solid portion 28 surrounding the inner annular core region 26. A cladding region 40 (“cladding”) surrounds the annular core 20 and has an outer surface. The cladding 40 may have low refractive index to provide a high numerical aperture (NA). The cladding 40 can be, for example, a low index polymer such as UV or thermally curable fluoroacrylate or silicone.

An optional coating 44 surrounds the cladding 40. Coating 44 may include a low modulus primary coating layer and a high modulus secondary coating layer. In at least some embodiments, coating layer 44 comprises a polymer coating such as an acrylate-based or silicone based polymer. In at least some embodiments, the coating has a constant diameter along the length of the fiber.

In other exemplary embodiments described below, coating 44 is designed to enhance the distribution and/or the nature of “radiated light” that passes from core 20 through cladding 40. The outer surface of the cladding 40 or the outer surface of optional coating 44 represents the “sides” 48 of fiber 12 through which light traveling in the fiber is made to exit via scattering, as described herein.

A protective cover or sheath (not shown) optionally covers cladding 40. Fiber 12 may include a fluorinated cladding 40, but the fluorinated cladding is not needed if the fibers are to be used in short-length applications where leakage losses do not degrade the illumination properties.

In some exemplary embodiments, the core region 26 of light diffusing fiber 12 comprises a glass matrix (“glass”) 31 with a plurality of non-periodically disposed nano-sized structures (e.g., “voids”) 32 situated therein, such as the example voids shown in detail in the magnified inset of FIG. 2. In another example embodiment, voids 32 may be periodically disposed, such as in a photonic crystal optical fiber, wherein the voids typically have diameters between about 1×10⁻⁶ m and 1×10⁻⁵ m. Voids 32 may also be non-periodically or randomly disposed. In some exemplary embodiment, glass 31 in region 26 is a fluorine-doped silica, while in other embodiments the glass is an undoped pure silica. Preferably the diameters of the voids are at least 10 nm.

The nano-sized structures 32 scatter the light away from the core 20 and toward the outer surface of the fiber. The scattered light is then “diffused” through the outer surface of the fiber 12 to provide the desired illumination. That is, most of the light is diffused (via scattering) through the sides of the fiber 12, along the fiber length. Preferably, the fiber emits substantially uniform radiation over its length, and the fiber has a scattering-induced attenuation of greater than 50 dB/km in the wavelength(s) of the emitted radiation (illumination wavelength). Preferably, the scattering-induced attenuation is greater than 100 dB/km for this wavelength. In some embodiments, the scattering-induced attenuation is greater than 500 dB/km for this wavelength, and in some embodiments it is greater than 1000 dB/km, greater than 2000 dB/km, or greater than 5000 dB/km. These high scattering losses are about 2.5 to 250 times higher than the Rayleigh scattering losses in standard single mode and multimode optical fibers.

Glass in core regions 22 and 28 may include updopants, such as Ge, Al, and/or P. By “non-periodically disposed” or “non-periodic distribution,” it is meant that when one takes a cross-section of the optical fiber (such as shown in FIG. 2), the voids 32 are randomly or non-periodically distributed across a portion of the fiber. Similar cross-sections taken at different points along the length of the fiber will reveal different cross-sectional void patterns, i.e., various cross-sections will have different voids patterns, wherein the distributions of voids and sizes of voids do not match. That is, the voids are non-periodic, i.e., they are not periodically disposed within the fiber structure. These voids are stretched (elongated) along the length (i.e. parallel to the longitudinal axis) of the optical fiber, but do not extend the entire length of the entire fiber for typical lengths of transmission fiber. While not wishing to be bound by theory, it is believed that the voids extend less than 10 meters, and in many cases less than 1 meter along the length of the fiber.

The light diffusing fiber 12 as used herein in the illumination system discussed below can be made by methods which utilize preform consolidation conditions which result in a significant amount of gases being trapped in the consolidated glass blank, thereby causing the formation of voids in the consolidated glass optical fiber preform. Rather than taking steps to remove these voids, the resultant preform is used to form an optical fiber with voids, or nano-sized structures, therein. The resultant fiber's nano-sized structures or voids are utilized to scatter or guide the light out of the fiber, via its sides, along the fiber length. That is, the light is guided away from the core 20, through the outer surface of the fiber, to provide the desired illumination.

As used herein, the diameter of a nano-sized structure such as a void is the longest line segment contained within the nano-sized structure whose endpoints are at the boundary of the nano-sized structure when the optical fiber is viewed in perpendicular cross-section transverse to the longitudinal axis of the fiber. A method of making optical fibers with nano-sized voids is described, for example, in U.S. patent application Ser. No. 11/583,098 (U.S. Patent Application Publication No. 2007/0104437 A1), which is incorporated herein by reference.

As described above, in some embodiments of fiber 12, core sections 22 and 28 comprise silica doped with germanium, i.e., germania-doped silica. Dopants other than germanium, singly or in combination, may be employed within the core, and particularly at or near the centerline 16, of the optical fiber to obtain the desired refractive index and density. In at least some embodiments, the relative refractive index profile of the optical fiber disclosed herein is non-negative in sections 22 and 28. These dopants may be, for example, Al, Ti, P, Ge, or a combination thereof. In at least some embodiments, the optical fiber contains no index-decreasing dopants in the core. In some embodiments, the relative refractive index profile of the optical fiber disclosed herein is non-negative in sections 22, 24 and 28.

In some examples of fiber 12 as used herein, the core 20 comprises pure silica. In one embodiment, a preferred attribute of the fiber is the ability to scatter light out of the fiber (to diffuse light) in the desired spectral range to which biological material is sensitive. In another embodiment, the scattered light may be used for decorative accents and white light applications. The amount of the loss via scattering can be increased by changing the properties of the glass in the fiber, the width of the nano-structured region 26, and the size and the density of the nano-sized structures.

In some examples of fiber 12 as used herein, core 20 is a graded-index core, and preferably, the refractive index profile of the core has a parabolic (or substantially parabolic) shape; for example, in some embodiments, the refractive index profile of core 20 has an α-shape with an a value of about 2, preferably between 1.8 and 2.3 as measured at 850 nm. In other embodiments, one or more segments of the refractive index profile have a substantially step index shape with an a value greater than 8, more preferably greater than 10 even more preferably greater than 20 as measured at 850 nm. In some embodiments, the refractive index of the core may have a centerline dip, wherein the maximum refractive index of the core, and the maximum refractive index of the entire optical fiber, is located a small distance away from centerline 16, but in other embodiments the refractive index of the core has no centerline dip, and the maximum refractive index of the core, and the maximum refractive index of the entire optical fiber, is located at the centerline.

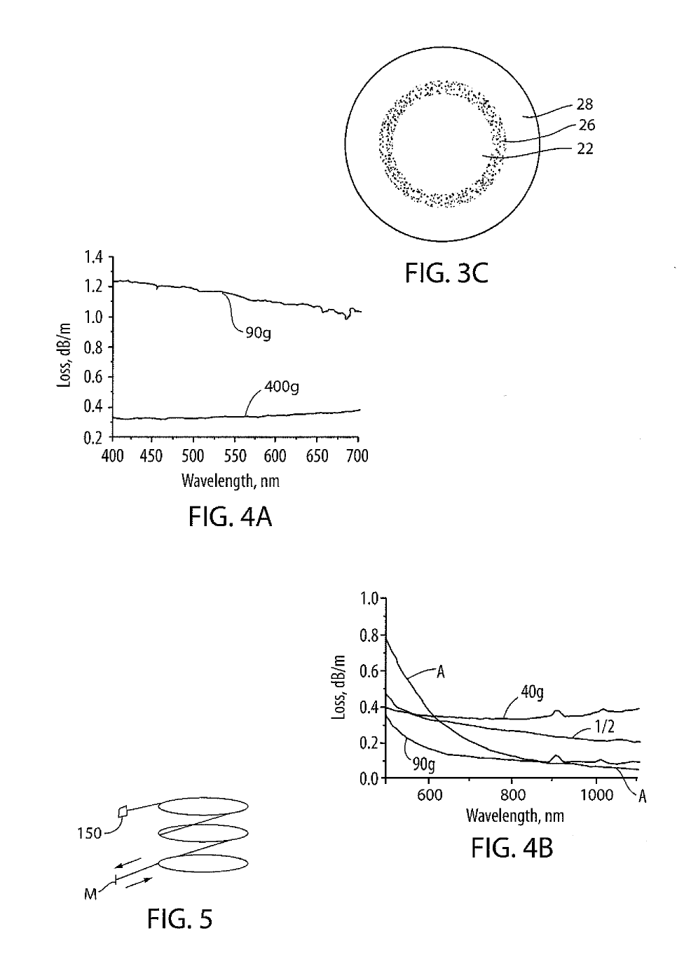

In an exemplary embodiment, fiber 12 has a silica-based core 20 and depressed index (relative to silica) polymer cladding 40. The low index polymer cladding 40 preferably has a relative refractive index that is negative, more preferably less than −0.5% and even more preferably less than −1%. In some exemplary embodiments cladding 40 has thickness of 20 μm or more. In some exemplary embodiments, cladding 40 has a lower refractive index than the core, and a thickness of 10 μm or more (e.g., 20 μm or more). In some exemplary embodiments, the cladding has an outer diameter 2 times Rmax, e.g., of about 125 82 m (e.g., 120 μm to 130 μm, or 123 μm to 128 μm). In other embodiments, the cladding has a diameter that is less than 120 μm, for example 60 or 80 μm. In other embodiments the outer diameter of the cladding is greater than 200 μm, greater than 300 μm, or greater than 500 μm. In some embodiments, the outer diameter of the cladding has a constant diameter along the length of fiber 12. In some embodiments, the refractive index of fiber 12 has radial symmetry. Preferably, the outer diameter 2R3 of core 20 is constant along the length of the fiber. Preferably, the outer diameters of core sections 22, 26, 28 are also constant along the length of the fiber. By constant, we mean that the variations in the diameter with respect to the mean value are less than 10%, preferably less than 5% and more preferably less than 2%. FIG. 3A is a plot of the exemplary relative refractive index Δ versus fiber radius for an example fiber 12 shown in FIG. 2 (solid line). The core 20 may also have a graded core profile, with α-profile having, for example, α-value between 1.8 and 2.3 (e.g., 1.8 to 2.1).

FIG. 3A is a plot of the exemplary relative refractive index Δ versus fiber radius for an example fiber 12 shown in FIG. 2 (solid line). The core 20 may also have a graded core profile, characterized, for example, by an α-value between 1.7 and 2.3 (e.g., 1.8 to 2.3). An alternative exemplary refractive index profile is illustrated by the dashed lines. Core region 22 extends radially outwardly from the centerline to its outer radius, R1, and has a relative refractive index profile Δ₁(r) corresponding to a maximum refractive index n1 (and relative refractive index percent 66 _{1MAX}). In this embodiment, the reference index n_{REF} is the refractive index at the cladding. The second core region (nano-structured region) 26 has minimum refractive index n₂, a relative refractive index profile Δ₂(r), a maximum relative refractive index Δ_{2MAX} , and a minimum relative refractive index Δ_{2MIN}, wherein some embodiments Δ_{2MAX}=Δ_{2MIN}. The third core region 28 has a maximum refractive index n₃, a relative refractive index profile Δ₃(r) with a maximum relative refractive index Δ_{3MAX} and a minimum relative refractive index Δ_{3MIN}, wherein some embodiments Δ_{3MAX}=Δ_{3MIN}. In this embodiment, the annular cladding 40 has a refractive index n₄, a relative refractive index profile Δ₄(r) with a maximum relative refractive index Δ_{4MAX} and a minimum relative refractive index Δ_{4MIN}. In some embodiments Δ_{4MAX}=Δ_{4MIN}. In some embodiments, Δ_{1MAX}>Δ_{4MAX} and Δ_{3MAX}>Δ_{4MAX}. In some embodiments Δ_{2MIN}>Δ_{4MAX}. In the embodiment shown in FIGS. 2 and 3A, Δ_{1MAX}>Δ_{3MAX}>Δ_{2MAX}>Δ_{4MAX}. In this embodiment, the refractive indices of the regions have the following relationship n₁>n₃>n₂>n₄.

In some embodiments, core regions 22, 28 have a substantially constant refractive index profile, as shown in FIG. 3A with a constant Δ₁(r) and Δ₃(r). In some of these embodiments, 4₂(r) is either slightly positive (0<Δ₂(r)<0.1%), negative (−0.1% <Δ₂(r)<0), or 0%>. In some embodiments, the absolute magnitude of Δ₂(r) is less than 0.1%, preferably less than 0.05%. In some embodiments, the outer cladding region 40 has a substantially constant refractive index profile, as shown in FIG. 3A with a constant Δ₄(r). In some of these embodiments, Δ₄(r)=0%. The core section 22 has a refractive index where Δ₁(r)>0%. In some embodiments, the void-filled region 26 has a relative refractive index profile Δ₂(r) having a negative refractive index with absolute magnitude less than 0.05%, and Δ₃(r) of the core region 28 can be, for example, positive or zero. In at least some embodiments, n₁>n₂ and n₃>n₄.

In some embodiments the cladding 40 has a refractive index −0.05%<Δ₄(r)<0.05%. In other embodiments, the cladding 40 and the core portions portion 20, 26, and 28 may comprise pure (undoped) silica.

In some embodiments, the cladding 40 comprises pure or F-doped silica. In some embodiments, the cladding 40 comprises pure low index polymer. In some embodiments, nano-structured region 26 comprises pure silica comprising a plurality of voids 32. Preferably, the minimum relative refractive index and the average effective relative refractive index, taking into account the presence of any voids, of nano-structured region 26 are both less than −0.1%. The voids or voids 32 may contain one or more gases, such as argon, nitrogen, oxygen, krypton, or SO₂ or can contain a vacuum with substantially no gas. However, regardless of the presence or absence of any gas, the average refractive index in nano-structured region 26 is lowered due to the presence of voids 32. Voids 32 can be randomly or non-periodically disposed in the nano-structured region 26, and in other embodiments, the voids are disposed periodically therein.

In some embodiments, the plurality of voids 32 comprises a plurality of non-periodically disposed voids and a plurality of periodically disposed voids.

In example embodiments, core section 22 comprises germania doped silica, core inner annular region 28 comprises pure silica, and the cladding annular region 40 comprises a glass or a low index polymer. In some of these embodiments, nano-structured region 26 comprises a plurality of voids 32 in pure silica; and in yet others of these embodiments, nano-structured region 26 comprises a plurality of voids 32 in fluorine-doped silica.

In some embodiments, the outer radius, Rc, of core is greater than 10 μm and less than 600 μm. In some embodiments, the outer radius Rc of core is greater than 30 μm and/or less than 400 μrn. For example, Rc may be 125 μm to 300 μm. In other embodiments, the outer radius Rc of the core 20 (please note that in the embodiment shown in FIG. 3A, Rc=R3) is larger than 50 μm and less than 250 μrn. The central portion 22 of the core 20 has a radius in the range 0.1 Rc≦R₁, <0.9 Rc, preferably 0.5 Rc≦R₁, ≦09 Rc. The width W2 of the nano-structured ring region 26 is preferably 0.05 Rc≦W2≦0.9 Rc, preferably 0.1 Rc≦W2≦0.9 Rc, and in some embodiments 0.5 Rc≦W2≦0.9 Rc (a wider nano-structured region gives a higher scattering-induced attenuation, for the same density of nano-sized structures). The solid glass core region 28 has a width Ws=W3 such that 0.1 Rc>W3>0.9 Rc. Each section of the core 20 comprises silica based glass. The radial width W₂ of nano-structured region 26 is preferably greater than 1 μrn. For example, W₂ may be 5 μm to 300 μm, and preferably 200 μm or less. In some embodiments, W₂ is greater than 2 μm and less than 100 μm. In other embodiments, W2 is greater than 2 μm and less than 50 μm. In other embodiments, W₂ is greater than 2 μm and less than 20 μm. In some embodiments, W₂ is at least 7 μm. In other embodiments, W₂ is greater than 2 μm and less than 12 μm. The width W₃ of core region 28 is (R3-R2) and its midpoint R_{3MID} is (R2+R3)/2. In some embodiments, W₃ is greater than 1 μm and less than 100 μm.

The numerical aperture (NA) of fiber 12 is preferably equal to or greater than the NA of a light source directing light into the fiber. Preferably the numerical aperture (NA) of fiber 12 is greater than 0.2, in some embodiments greater than 0.3, and even more preferably greater than 0.4.

In some embodiments, the core outer radius R1 of the first core region 22 is preferably not less than 24 μm and not more than 50 μm, i.e. the core diameter is between about 48 and 100 μm. In other embodiments, R1>24 microns; in still other embodiments, R1>30 microns; in yet other embodiments, R1>40 microns.

In some embodiments, |Δ₂(r)|<0.025% for more than 50% of the radial width of the annular inner portion 26, and in other embodiments |Δ₂(r)|<0.01% for more than 50% of the radial width of region 26. The depressed-index annular portion 26 begins where the relative refractive index of the cladding first reaches a value of less than −0.05%, going radially outwardly from the centerline. In some embodiments, the cladding 40 has a relative refractive index profile Δ₄(r) having a maximum absolute magnitude less than 0.1%, and in this embodiment Δ_{4MAX}<0.05% and Δ_{4MIN}>−0.05%, and the depressed-index annular portion 26 ends where the outermost void is found.

Cladding structure 40 extends to a radius R4, which is also the outermost periphery of the optical fiber. In some embodiments, the width of the cladding, R4-R3, is greater than 20 μm; in other embodiments R4-R3 is at least 50 μm, and in some embodiments, R4-R3 is at least 70 μm.

In another embodiment, the entire core 20 is nano-structured (filled with voids, for example), and the core 20 is surrounded by the cladding 40. The core 20 may have a “step” refractive index delta, or may have a graded core profile, with a-profile having, for example, α-value between 1.8 and 2.3.

Preparation of optical preform and fibers for examples shown in FIGS. 3C, 4A and 6-8 were as follows: In this exemplary embodiment, 470 grams of SiO₂ (0.5 g/cc density) soot were deposited via outside vapor deposition (OVD) onto a fully consolidated 1 meter long, 20 mm diameter pure silica void-free core cane, resulting in a preform assembly (sometimes referred to as a preform, or an optical preform) comprising a consolidated void-free silica core region which was surrounded by a soot silica region. The soot cladding of this perform assembly was then sintered as follows. The preform assembly was first dried for 2 hours in an atmosphere comprising helium and 3 percent chlorine (all percent gases by volume) at 1100° C. in the upper-zone part of the furnace, followed by down driving at 200 mm/min (corresponding to approximately a 100° C./min temperature increase for the outside of the soot preform during the downdrive process) through a hot zone set at approximately 1500° C. in a 100 percent SO₂ (by volume) sintering atmosphere. The preform assembly was then down driven again (i.e., a second time) through the hot zone at the rate of 100 mm/min (corresponding to an approximately 50° C./min temperature increase for the outside of the soot preform during the downdrive process). The preform assembly was then down driven again (i.e., a third time) through the hot zone at the rate of 50 mm/min (corresponding to an approximately 25° C./min temperature increase for the outside of the soot preform during the downdrive process). The preform assembly was then down driven again (i.e., a fourth time) through the hot zone at the rate of 25 mm/min (corresponding to an approximately 12.5° C./min temperature increase for the outside of the soot preform during the downdrive process), then finally sintered at 6 mm/min (approximately 3° C./min heat up rate) in order to sinter the soot into an SO₂-seeded silica overclad preform. Following each downdrive step, the preform assembly was updriven at 200 mm/min into the upper-zone part of the furnace (which remained set at 1100° C.). The first series of higher downfeed rate are employed to glaze the outside of the optical fiber preform, which facilitates trapping of the gases in the preform. The preform was then placed for 24 hours in an argon purged holding oven set at 1000° C. to outgas any remaining helium in the preform. This preform was then redrawn in an argon atmosphere on a conventional graphite redraw furnace set at approximately 1700° C. into void-free SiO₂ core, SO₂-seeded (i.e., containing the non-periodically located voids containing SO₂ gas) silica overclad canes which were 10 mm in diameter and 1 meter long.

One of the 10 mm canes was placed back in a lathe where about 190 grams of additional SiO₂ (0.52 g/cc density) soot was deposited via OVD. The soot of this cladding (which may be called overcladding) for this assembly was then sintered as follows. The assembly was first dried for 2 hours in an atmosphere consisting of helium and 3 percent chlorine at 1100° C. followed by down driving at 5 mm/min through a hot zone set at 1500° C. in a 100% helium (by volume) atmosphere in order to sinter the soot to a germania containing void-free silica core, silica SO₂-seeded ring (i.e. silica with voids containing SO₂), and void-free overclad preform. The preform was placed for 24 hours in an argon purged holding oven set at 1000° C. to outgas any remaining helium from the preform. The optical fiber preform was drawn to 3 km lengths of 125 micron diameter optical fiber at approximately 1900° C. to 2000° C. in a helium atmosphere on a graphite resistance furnace. The temperature of the optical preform was controlled by monitoring and controlling the optical fiber tension; in this embodiment the fiber tension was held at one value between 30 and 600 grams during each portion (e.g., 3 km lengths) of a fiber draw run. The fiber was coated with a low index silicon based coating during the draw process.

Another 10 mm void-free silica core SO₂-seeded silica overclad canes described above (i.e., a second cane) was utilized to manufacture the optical preform and fibers for examples shown in FIG. 4B. More specifically, the second 10 mm void-free silica core SCV seeded silica overclad cane was placed back in a lathe where about 3750 grams of additional SiO₂ (0.67 g/cc density) soot are deposited via OVD. The soot of this cladding (which may be called overcladding for this assembly) was then sintered as follows. The assembly was first dried for 2 hours in an atmosphere comprising of helium and 3 percent chlorine at 1100° C., followed by down driving at 5 mm/min through a hot zone set at 1500° C. in a 100% helium (by volume) atmosphere in order to sinter the soot so as to produce preform comprising germania containing void-free silica core, silica SO₂-seeded ring (i.e. silica with voids containing SO₂), and void-free overclad. The resultant optical fiber preform was placed for 24 hours in an argon purged holding oven set at 1000° C. to outgas any remaining helium from the preform. Finally, the optical fiber preform was drawn to 5 km lengths of 125 micron diameter optical fiber and coated with the low index polymer as described above.

FIG. 3B illustrates schematically yet another exemplary embodiment of light diffusing fiber 12. The fiber of FIG. 3B includes a core 20 with a relative refractive index Δ₁, a nano-structured region 26′ situated over and surrounding the core 20. The core 20 may have a “step” index profile, or a graded core profile, with a-profile having, for example, α-value between 1.8 and 2.3.

In this exemplary embodiment (see FIG. 3B), the nano-structured region 26′ is an annular ring with a plurality of voids 32. In this embodiment, the width of region 26′ can be as small as 1-2 μm, and may have a negative average relative refractive index Δ₂. Cladding 40 surrounds the nano- structured region 26′. The (radial) width of cladding 40 may be as small as 1 μm, and the cladding may have either a negative, a positive or 0% relative refractive index, (relative to pure silica). The main difference between examples in FIGS. 3A and 3B is that nano-structured region in shown in FIG. 3A is located in the core 20 of the light diffusing fiber 12, and in FIG. 3B it is located at the core/clad interface. The depressed-index annular portion 26′ begins where the relative refractive index of the core first reaches a value of less than −0.05%, going radially outwardly from the centerline. In the embodiment of FIG. 3B, the cladding 40 has a relative refractive index profile Δ₃(r) having a maximum absolute magnitude less than 0.1%, and in this embodiment Δ_{3MAX}<0.05% and Δ₃MIN>−0.05%, and the depressed-index annular portion 26 ends where the outmost void occurs in the void-filled region.

In the embodiment shown in FIG. 3B, the index of refraction of the core 20 is greater than the index of refraction n₂ of the annular region 26′, and the index of refraction n₁ of the cladding 40 is also greater than the index of refraction n₂.

FIG. 3C illustrates a core 20 of one embodiment of an optical fiber 12 that has been made. This fiber has a first core region 22 with an outer radius R1 of about 33.4 μm, a nano-structured region 26 with an outer radius R2=42.8 μm, a third core region 28 with an outer radius R3=62.5 μm, and a polymer cladding 40 with an outer radius R4 (not shown) of 82.5 μm). In this embodiment, the material of the core is pure silica (undoped silica), the material for cladding was low index polymer (e.g., UV curable silicone having a refractive index of 1.413 available from Dow-Corning of Midland, Mich. under product name Q3-6696) which, in conjunction with the glass core, resulted in fiber NA of 0.3. The optical fiber 12 had a relatively flat (weak) dependence on wavelength, compared to standard single-mode transmission fiber, such as for example SMF-28e^{R} fiber, FIG. 4B. In standard single mode (such as SMF-28^{R}) or multimode optical fibers, the losses at wavelengths less than 1300 nm are dominated by Rayleigh scattering. These Rayleigh scattering losses are determined by the properties of the material and are typically about 20 dB/km for visible wavelengths (400-700 nm). The wavelength dependence of Rayleigh scattering losses is proportional to λ^{-p} with p˜4. The exponent of the wavelength dependent scattering losses in the fiber comprising at least one nanostructured region is less than 2, preferably less than 1 over at least 80% (for example greater than 90%) in the 400 nm-1100 nm wavelength range. The average spectral attenuation from 400 nm to 1100 nm was about 0.4 dB/m when the fiber was drawn with at 40 g tension and was about 0.1 dB/m when the fiber 12 was drawn at 90 g tension. In this embodiment, the nano-sized structures contain SO₂ gas. Applicants found that filled SO₂ voids in the nano-structured ring greatly contribute to scattering. Furthermore, when SO₂ gas was used to form the nano-structures, it has been discovered that this gas allows a thermally reversible loss to be obtained, i.e., below 600° C. the nano-structured fiber scatters light, but above 600° C. the same fiber will guide light. This unique behavior that SO₂ imparts is also reversible, in that upon cooling the same fiber below 600° C., the fiber 12 will act as light diffusing fiber and will again generate an observable scattering effect.

In preferred embodiments, the uniformity of illumination along the fiber length is controlled such that the minimum scattering illumination intensity is not less than 0.7 of the maximum scattering illumination intensity, by controlling fiber tension during the draw process; or by selecting the appropriate draw tension (e.g., between 30 g and 100 g, or between 40 g and 90 g).

Accordingly, according to some embodiments, a method of making a light diffusing fiber to control uniformity of illumination along the fiber length wherein the minimum scattering illumination intensity is not less than 0.7, the maximum scattering illumination intensity includes the step of controlling fiber tension during draw process.

The presence of the nano-sized structures in the light diffusing fiber 12 creates losses due to optical scattering, and the light scattering through the outer surface of the fiber can be used for illumination purposes. FIG. 4A is a plot of the attenuation (loss) in dB/m versus wavelength (nm) for the fiber of FIG. 3C (fiber with SO₂ gas filled voids). FIG. 4A illustrates that (i) light diffusing fibers 12 can achieve very large scattering losses (and thus can provide high illumination intensity) in the visible wavelength range. The scattering losses of the optical fiber 12 also have weak wavelength dependence (Lₛ is proportional to 1/λ^{-p}, where p is less than 2, preferably less than 1, and even more preferably less than 0.5), as compared to regular 125 μm graded index core multi mode comparative fiber A (fiber A is a step index multimode fiber without the nano-structured region) which has Rayleigh scattering losses of about 0.02 dB/m in the visible wavelength range, or about 20 dB/km at the wavelength of 500 nm and relatively strong wavelength dependence of 1/λ⁻⁴). The effect of the tension for the fibers 12 is also illustrated in FIGS. 4A-4B. More specifically, FIGS. 4A-4B illustrate that the higher fiber draw tension results in lower scattering losses, and that lower fiber draw tension results in a fiber section with higher scattering loss, i.e., stronger illumination). FIG. 4A depicts attenuation as function of wavelength for light diffusing fiber 12 (with voids in the core) drawn at different fiber tensions of 90 and 400 g. FIG. 4B depicts attenuation as function of wavelength for different light diffusing fiber 12 (with voids in the core) drawn at different fiber tension, 90 and 40 g, a comparative multiple mode fiber (fiber A) with normalized loss, and a theoretical fiber with 1/λ. loss dependence. (Note, FIG. 4B graph describes wavelength dependence of the loss. In this example, in order to compare the slope of the scattering for the light fiber 12 and fiber A, the loss of low loss fiber (fiber A) was multiplied by a factor of 20, so that the two plots can be easily shown on the same Figure). Without being bound to any particular theory, it is believed that the increase in the scattering losses when the draw tension decreases, for example from 90 g to 40 g, is due to an increase in the average diameter of the nanostructures. Therefore, this effect of fiber tension could be used to produce constant attenuation (illumination intensity) along the length of the fiber by varying the fiber tension during the draw process. For example, a first fiber segment drawn at high tension, T1, with a loss of α₁ dB/m and length, L1, will attenuate the optical power from an input level P0 to P0 exp(−α₁*L1/4.343). A second fiber segment optically coupled to the first fiber segment and drawn at lower tension T2 with a loss of α₂ dB/m and length L2 will further attenuate the optical power from P0 exp(−α₁*L1/4.343) to P0 exp(−α₁*L1/4.343) exp(−α₂*L2/4.343). The lengths and attenuations of the first and second fiber segments can be adjusted to provide uniform intensity along the length of the concatenated fiber.

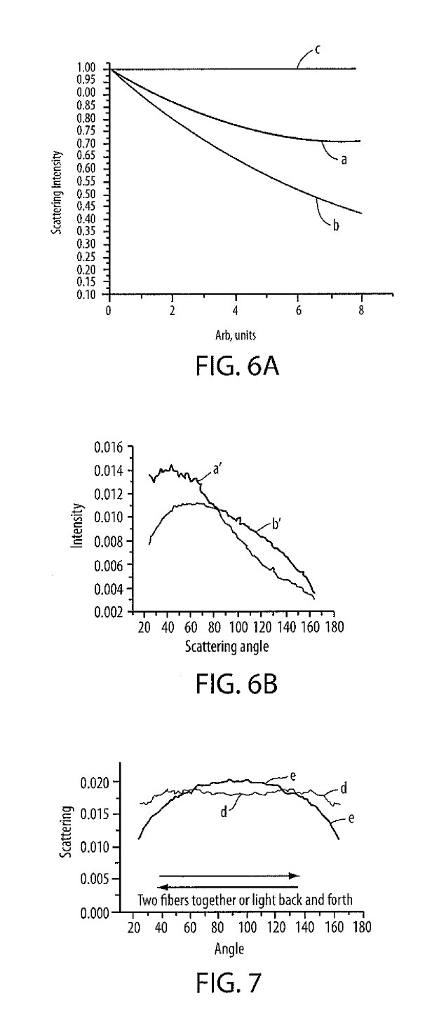

One of the advantages of light diffusing fibers 12 is their ability to provide uniform illumination along the length of the light diffusing fiber. FIG. 5 illustrates the arrangement of fiber 12 that results in uniform illumination along the length of the fiber and utilizes two light passes in the single light diffusing fiber 12. In this arrangement, a mirror M is placed at the end of the light diffusing fiber 12. The input light provided by the light source 150 to the light diffusing fiber 12 propagates along the axis of the light diffusing fiber 12, and the remaining light is reflected by the mirror and propagates back along the axis of the fiber 12 towards the input. If the attenuation and length of the fiber 12 are chosen properly, the light output power provided back to the light source is less than a 2%-5% percent of the original light power. The scattering loss intensity for fiber with constant loss distribution (see FIG. 4A) may be higher in the beginning of the fiber and weaker at the end of the fiber. However, if the light diffusing fiber 12 is drawn with a periodically controlled tension (the tension value is related to the furnace temperature, which may vary from 1800° C. to 2100° C.) such that the scattering losses are lower at the beginning of the fiber, where the intensity is high, and higher at the end, where the intensity is lower, the resulting scattering intensity can be made less variable, or constant (for example, as shown in FIG. 6A, example C). The fiber draw tension may be controlled and varied, for example, between 40 g and 400 g, thus providing a wide range of scattering-induced attenuation (e.g., up to 6 times). The mirror M in FIG. 5 may also be replaced by a second light source with power density output that is similar to that of the first light source (within a factor of 2, i.e., in the range of 50% to 200%) to not only create a more uniform illumination, but also to increase the quantity of light scattered by the fiber.

One aspect of an exemplary embodiment of the light-diffusing optical fibers used herein is that the angular distribution of the scattering light intensity is uniform or nearly uniform in angular space. The light scattering axially from the surface of the fiber has a variation relative to the mean scattering intensity that is less than 50%, preferably less than 30%, preferably less than 20% and more preferably less than 10%. The dominant scattering mechanism in conventional silica-based optical fibers without nano-sized structures is Rayleigh scattering, which has a broad angular distribution. Fibers 12 in which there are additional scattering losses due to voids in nano-structured ring may have a strong forward component, as shown in FIG. 6A (embodiments a and b) and FIG. 6B (embodiment a′). This distribution, however, can be corrected by placing a scattering material on the top of coating of the light diffusing fiber 12. Light diffusing fibers made with coating containing TiO₂ based white ink (see FIG. 6B, embodiment b′) provide an angular distribution of scattered light that is significantly less forward biased. With an additional thicker layer of TiO₂ ink (e.g., 1-5 μm) it is possible to further reduce the forward scattering component, thereby increasing the uniformity of the angular intensity distribution. However, as shown in FIG. 7, scattering for fiber(s) optically coupled to a back reflective mirror or additional light source (see FIG. 5), is relatively flat (i.e., very uniform). In some embodiments, a controlled variation of the ink coating (either thickness of the ink coating or variation of ink concentration in the coating) along the length of the fiber will provide an additional way of making more uniform variation in the intensity of the light scattered from the fiber at large angles (more than 15 degrees).

In some embodiments the luminophoric ink can be a fluorescent material that converts scattered light to a longer wavelength of light. In some embodiments, white light can be emitted (diffused out of the outer surface) by the fiber 12 by coupling the light diffusing fiber 12 with such a coating to a UV light source, for example a 405 nm or 445 nm diode laser. The angular distribution of fluorescence white light in the exemplary embodiments is substantially uniform (e.g., 25% to 400%, preferably 50% to 200%, even more preferably 50% to 150%, or 70% to 130%, or 80% to 120% in angular space).

Efficient coupling to low cost light sources such as light emitting diodes (LEDs) requires the fiber to have a high NA and large core diameter. With a design similar to that shown in FIG. 2, the size of the multimode core 20 can be maximized, and may have a radius up to 500 μm. The cladding thickness may be much smaller, for example, about 15-30 μm (e.g., about 20 μm). For example, according to one embodiment, a plurality of light diffusing fibers 12 may be wound around a support structure, and each light diffusing optical fiber may be optically coupled to either the light source or a plurality of light sources. The plurality of light diffusing optical fibers 12 can be bundled together in at least one of: a ribbon, ribbon stack, or a round bundle. The fiber bundles or ribbons (i.e., collections of multiple fibers) can also be arranged in the shape of the light source in order to increase coupling efficiency. A typical bundle/ ribbon structure can include, for example, 2-36 light diffusing fibers 12, or may include up to several hundred fibers 12. Cable designs which are assemblies of multiple fibers are well known and could include ribbons, collections of multiple ribbons, or fibers gathered into a tube. Such fibers may include one or more light diffusing fibers 12.

A bright continuous light source coupled into a light diffusing fiber can be utilized for different application such as signs, or display illumination. If the illumination system utilizes a single fiber 12 with core diameter of 125-300 μm, a multimode laser diode could be used as a light source for providing light into the fiber 12.

According to some embodiments, the light diffusing fiber 12 includes a core at least partially filled with nanostructures for scattering light, a cladding surrounding the core, and at least one coating surrounding the cladding. For example, the core and cladding may be surrounded by primary and secondary coating layers, and/or by an ink layer. In some embodiments, the ink layer contains pigments to provide additional absorption and modify the spectrum of the light scattered by the fiber (e.g., to provide additional color(s) to the diffused light). In other embodiments, one or more of the coating layers comprises molecules which convert the wavelength of the light propagating through the fiber core such that the light emanating from the fiber coating (light diffused by the fiber) is at a different wavelength. In some embodiments, the ink layer and/or the coating layer may comprise phosphor in order to convert the scattered light from the core into light of differing wavelength(s). In some embodiments, the phosphor and/or pigments are dispersed in the primary coating. In some embodiments the pigments are dispersed in the secondary coating, in some embodiments the pigments are dispersed in the primary and secondary coatings. In some embodiments, the phosphor and/or pigments are dispersed in the polymeric cladding. Preferably, the nanostructures are voids filled SO₂.

According to some embodiments, the optical fiber 12 includes a primary coating, an optional secondary coating surrounding the primary coating and/or an ink layer (for example located directly on the cladding, or on one of the coatings. The primary and/or the secondary coating may comprise at least one of: pigment, phosphors, fluorescent material, UV absorbing material, hydrophilic material, light modifying material, or a combination thereof.

According to some embodiments, a light diffusing optical fiber includes: (1) a glass core, a cladding, and a plurality of nano-sized structures situated within said core or at a core-cladding boundary, the optical fiber further including an outer surface and is configured to (i) scatter guided light via said nano-sized structures away from the core and through the outer surface, (ii) have a scattering-induced attenuation greater than 50 dB/km at illumination wavelength; and (2) one or more coatings, such that either the cladding or at least one coating includes phosphor or pigments. According to some embodiments, these pigments may be capable of altering the wavelength of the light such that the illumination (diffused light) provided by the outer surface of the fiber is of a different wavelength from that of the light propagating through fiber core. Preferably, the nanostructures are voids filled SO₂.

According to some embodiments, a light diffusing optical fiber includes: a glass core, a cladding, and a plurality of nano-sized structures situated within said core or at a core-cladding boundary. The optical fiber further includes an outer surface and is configured to (i) scatter guided light via said nano-sized structures away from the core and through the outer surface, (ii) have a scattering-induced attenuation greater than 50 dB/km at illumination wavelength; wherein the entire core includes nano-sized structures. Such fiber may optionally include at least one coating, such that either the cladding or at least one coating includes phosphor or pigments. According to some embodiments the nanostructures are voids filled SO₂.

According to some embodiments, a light diffusing optical fiber includes: a glass core, and a plurality of nano-sized structures situated within said core such that the entire core includes nano-structures, the optical fiber further including an outer surface and is configured to (i) scatter guided light via said nano-sized structures away from the core and through the outer surface, (ii) have a scattering-induced attenuation greater than 50 dB/km at illumination wavelength, wherein the fiber does not include cladding. According to some embodiments, the nanostructures are voids filled SO₂. The SO₂ filled voids in the nano-structured area greatly contribute to scattering (improve scattering).

According to some embodiments, a light diffusing optical fiber includes: a glass core, and a plurality of nano-sized structures situated within said core such that the entire core includes nano-structures, said optical fiber further including an outer surface and is configured to (i) scatter guided light via said nano-sized structures away from the core and through the outer surface, (ii) have a scattering-induced attenuation greater than 50 dB/km at illumination wavelength wherein said fiber does not include cladding. According to some embodiments, the fiber includes at least one coating such that either the cladding or the coating includes phosphor or pigments. According to some embodiments, the nanostructures are voids filled SO₂. As stated above, the SO₂ filled voids in the nano-structured area greatly contribute to scattering (improve scattering).

The light diffusing optical fiber can be used either alone in the fabric or in combination with conventional textile fibers, including natural fibers such as qiviut, yak, rabbit, wool (including lambswool, cashmere wool, mohair wool, alpaca wool, vicuna wool, guanaco, llama wool and angora wool), camel hair, silk, byssus, chiengoro, abaca, coir, cotton, flax, jute, kapok, kenaf, raffia, bamboo, hemp, modal, pina, ramie, and sisal; synthetic fibers such as rayon (viscose), acetate, tencel, polyester, aramid, acrylic, inego, luminex, lurex, lyocell, nylon, spandex (lycra), olefin and polylactide; and/or mineral-based fibers such as glass or metal (e.g., gold or silver).

In a woven fabric, the light-diffusing optical fibers may constitute either the warp threads, the weft threads or both warp and weft threads. The light-diffusing optical fibers can be combined into bundles and twisted to produce yarns that may be used in woven, knitted, crocheted or other fabrics.

In a non-woven fabric, the light-diffusing optical fiber(s) can be embedded in fibrous web structures that are held together by entanglement and/or chemically or thermally induced bonding. For example, the light-diffusing optical fiber(s) can be embedded in the non-woven material during a hydroentanglement or needle-punching process, or during a bonding step. The light-diffusing fiber(s) can be embedded randomly or in a predetermined pattern.

Conventional textile equipment and processes may be employed in the manufacture of the disclosed luminary textiles.

Each light-diffusing optical fiber in the fabric or textile can be coupled at one or both of its ends to one or a plurality of different light sources. Different light sources emitting radiation at different wavelength that stimulate luminescence of different luminophores in one or more luminophore coating(s) applied to the light-diffusing optical fibers may be used to create multiple colored light patterns that can be selectively displayed by controlling power to the light sources.

One or more coatings may be applied to individual light-diffusing fibers before these fibers are incorporated into the fabric. Additionally or alternatively, one or more coatings may be applied, each in a desired pattern, to the fabric, after it is made from the fibers. The various coatings, either applied to the fibers before they are incorporated in the fabric or to the fabric after it has been produced from the fibers, may comprise one or more luminophores (e.g., fluorophores or phosphors), one or more pigment, and/or one or more dyes to provide various colors, patterns and visual effects. Patterns can be applied to the fabric employing conventional screen printing techniques, stencils, ink jet printers, etc. Pigments can be selected to diffuse light. For example, a white ink may be employed (applied to the fibers before they are incorporated into the fabric or applied to the finished fabric) as a base layer to diffuse light from the fiber, and the luminophore coating may then be applied over the white ink coating layer or portions thereof.

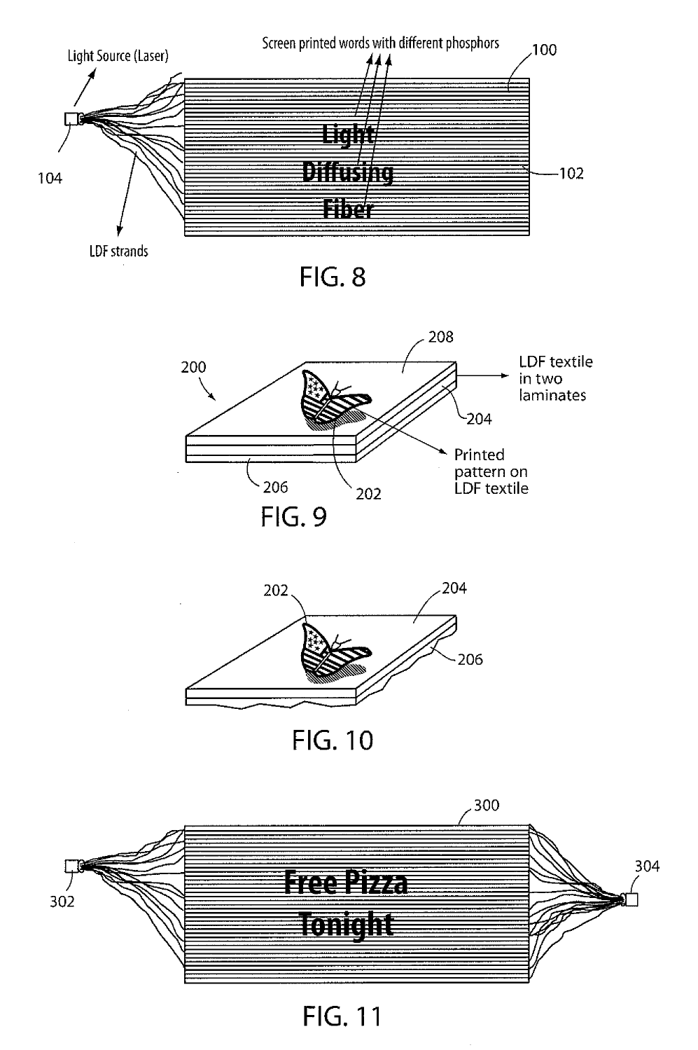

FIG. 8 shows a fabric 100 with screen printed words, each word printed using a coating containing a different luminophore. The fabric includes a plurality of parallel light-diffusing fibers 102, each coupled to a laser light source 104. For example, the first word “LIGHT” can be printed with a luminophore coating containing a first luminophore that luminesces at a certain first wavelength (e.g., to emit red light), whereas the luminophore for the other words can be selected to emit at second and third wavelengths (e.g., to emit green and blue light).

FIG. 9 shows a sign or display 200 in which a butterfly pattern 202 is printed on a fabric 204 comprised of light-diffusing optical fibers (similar to that shown in FIG. 8). The fabric 204 is laminated between a base layer 206 and a top layer 208. Layers 206 and 208 may be comprised of any of a variety of materials (e.g., plastic, glass, metal, wood), provided at least one of the layers 206 and 208, or both layers, are transparent to visible light (at least at those wavelengths constituting the displayed pattern 202). Alternatively, as shown in FIG. 10, fabric 204 having printed pattern 202 can be laminated to a base layer 206, that may or may not be transparent, without including a top layer.

FIG. 11 shows a fabric 300 on which the words “FREE PIZZA” are screen printed using a first luminophore that luminesces at a first wavelength when stimulated by a first source 302 (e.g., to emit green light). The word “TONIGHT” is printed below the words “FREE PIZZA” using a second luminophore that luminesces at a second wavelength when stimulated by a second source 304 (e.g., to emit red light). By switching or controlling the power to sources 302 and 304, it is possible to illuminate the words “FREE PIZZA” and “TONIGHT” at different times.

It is to be understood that the foregoing description is exemplary of certain embodiments and is intended to provide an overview for the understanding of the nature and character of the claims. The drawings are included to provide a further understanding of the claims and are incorporated and constitute part of the specification. The drawings illustrate various features in the embodiments, which, together with their description, serve to explain the principles and operation of the claimed subject matter.

It will be apparent to those skilled in the art that various modifications and variations can be made without departing from the spirit or scope of the claims.

What is claimed is:

1. A luminary textile, comprising:
fibers incorporated into a fabric, including at least one fiber that is a light diffusing optical fiber;
at least one light source coupled to the light diffusing fiber; and
at least one luminophore coating applied either directly to the fabric or over a subcoating applied to the fabric, and disposed on or over at least a section of the light diffusing fiber.

2. The textile of claim 1, in which the light source comprises a laser.

3. The textile of claim 1, in which the light source comprises a light emitting diode.

4. The textile of claim 1, in which the luminophore coating comprises a phosphor or a fluorophore.

5. The textile of claim 1, in which a plurality of different luminophore coatings are applied to different sections of the fabric and are disposed on different sections of the light diffusing fiber to provide light of a plurality of different colors from the textile.

6. The textile of claim 1, in which a plurality of parallel light diffusing optical fibers are incorporated into the fabric, each coupled to a light source.

7. The textile of claim 6, in which at least two different light sources emitting light at different wavelengths are coupled to the light diffusing optical fibers.

8. The textile of claim 1, in which the luminophore coating is printed onto the fabric.

9. The textile of claim 1, further comprising at least one pigmented coating applied to at least a section of the fabric.

10. The textile of claim 1, further comprising at least one dye coating applied to at least a section of the fabric.

11. The textile of claim 1, further comprising a subcoating disposed between at least a section of the fabric and the luminophore coating.

12. Signage comprising the luminary textile of claim 1.

13. The signage of claim 12, in which the luminary textile is positioned as a layer between two transparent layers.

14. A decorative luminary wall panel, table top or desk top comprising the luminary textile of claim 1 positioned between a substrate layer and a layer that is at least partially transparent.

15. The decorative luminary wall panel, table top or desk top of claim 14 in which the substrate is opaque.

16. The decorative luminary wall panel, table top or desk top of claim 14 in which the substrate is at least partially transparent.

17. The textile of claim 1, in which the light diffusing fiber is coupled to a plurality of light sources, the intensity of each light source being individually controllable to facilitate a changing color effect.

18. The textile of claim 1, in which the fabric is a non-woven fabric.
